(19) United States
(12) Patent Application Publication
(10) Pub. No.: US 2019/0126675 A1
(43) Pub. Date: May 2, 2019

(54) SMALL DOUBLE-ROW OMNI-DIRECTIONAL WHEEL

(71) Applicant: GJS CO.,Ltd, Shenzhen (CN)

(72) Inventors: Jinlong ZHANG, Shenzhen (CN); Zhaohong LI, Shenzhen (CN); Junjian ZHAO, Shenzhen (CN)

(21) Appl. No.: 15/841,222

(22) Filed: Dec. 13, 2017

(30) Foreign Application Priority Data
Oct. 30, 2017 (CN) 201711052652.X
Oct. 30, 2017 (CN) 201721413507.5

(51) Int. Cl. B60B 19/00; B60B 19/12

(52) U.S. Cl. CPC B60B 19/003; B60B 19/12

(57) ABSTRACT

The present invention relates to the field of robot movement technology, and discloses a small double-row omni-directional wheel. The wheel includes a middle fixed base, a first fixed bottom cover, a second fixed bottom cover and a small roller assembly. Two rows of mutually parallel staggered grooves are uniformly arranged in the two sides of the middle fixed base. The small roller assembly is fixed in the grooves, the first fixed bottom cover and the second fixed bottom cover are respectively fixed on the two sides of the middle fixed base. The small roller assembly comprises a small roller, a small roller rolling shaft and a rubber sleeve. The present invention has the characteristics of low cost, simple structure, light weight, long service life, attractive appearance, high moving speed and high cost performance, and is suitable for a small-sized robot movement platform.

### TECHNICAL FIELD

The present invention relates to the field of robot movement technology, and more specifically to a small double-row omni-directional wheel.

### BACKGROUND OF THE PRESENT INVENTION

Omni-directional wheel is a special wheel that rolls freely in both directions and realizes omni-directional movement. Normal wheel can only rotate forwards or backwards and cannot move to the side, that is, it can only move back, forth and turn around, cannot move laterally and circling in place, making the robot slower and less efficient in achieving its goals. By using the omni-directional wheel, the movement of three degrees of freedom from front to back, left and right, self-rotation can be realized, and 360-degree omni-directional movement can be achieved; if the wheel has the full three degrees of freedom, it is called an omni-directional movement platform, the platform is very suitable for working in the occasions with narrow and limited space and high requirement of the maneuverability platform.

Most of the existing omni-directional wheels adopt a single-row structure mode composed of one wheel disc and a small roller fixed on the periphery of the wheel disc, the axis of the wheel disc is perpendicular to the axis of the small roller, the wheel disc is driven by a motor to rotate around the axis, the small roller is in contact with the ground in sequence and freely rotating around the self axis, and maintaining the rolling stability of driving wheel through the fact that the roller on the hub are in contact with the ground in sequence. Due to the formation of a certain angle in a staggered mode between the small rollers on the periphery of the wheel disc, the wheel edge of the small roller is a straight line, and the outer circle of the omni-directional wheel formed by fitting all the small rollers is actually not a complete circle instead of a polygon, however, the gap between every two adjacent small rollers is usually large, so that the height of the contact points of the wheels and the ground in the rotating process continuously changes, causing the vehicle body to vibrate or slip, and influencing the rolling stability of the driving wheel. Besides, in the existing omni-directional wheel, the general size is large, the structure is relatively complicated, therefore the cost is relatively high;,for a small robot, this is undoubtedly a waste and the moving speed is relatively reduced; in addition, because of material problems, the traditional omni-directional wheel are comparatively heavy and bulky in appearance, and the portability of the small-sized robot is influenced.

### SUMMARY OF THE PRESENT INVENTION

In view of the above defects of the prior art, the present invention aims to provide a small double-row omni-directional wheel that is lighter, more stable, less noise and less cost, and suitable for a small-sized robot movement platform.

In order to achieve the purpose, the technical scheme adopted by the present invention is as follows:

a small double-row omni-directional wheel, comprising a middle fixed base, a first fixed bottom cover, a second fixed bottom cover and a small roller assembly; the middle of the middle fixed base is provided with a motor rotating shaft mounting hole for fixedly connecting with a motor rotating shaft, and the middle fixed base is driven by a motor to rotate around the axis; two rows of mutually parallel staggered grooves perpendicular to the axis of the middle fixed base are uniformly arranged in the two sides of the middle fixed base, the number of the grooves is 10, and the number of grooves for each row is 5; the small roller assembly is fixed in the grooves, that is, the axis of the middle fixed base is perpendicular to the axis of the small roller; the first fixed bottom cover and the second fixed bottom cover are respectively fixed on the two sides of the middle fixed base; the small roller assembly comprises a small roller, a small roller rolling shaft and a rubber sleeve; a rolling shaft groove is arranged in the two sides of the middle of each grooves, the small roller rolling shaft is arranged in the rolling shaft groove, and the small roller is rotatably fixed on the small roller rolling shaft and rotates around the rolling shaft, that is, the small roller is in contact with the ground in sequence and freely rotating around the self axis; and the rubber sleeve is wrapped on an outer surface of the small roller, effectively reducing the vibration. In this way, the height of the contact points of the wheels and the ground in the rotating process is not changed and avoiding vibration of the robot, it is also guaranteed that the small roller can freely roll in the parallel direction of the wheel disc shaft at any position. The operation of the wheel is more stable, and noise is effectively reduced.

Further, the middle fixed base, the first fixed bottom cover and the second fixed bottom cover are made of high-strength plastic materials and integrally formed, so that the weight is effectively reduced, and the requirement for portability of the small robot is met.

Further, an included angle between two adjacent small rollers is 72 degrees, an angle of 36 degrees is formed between two rows of the small rollers in a staggered mode, and an outer circle diameter formed by fitting each row of the small rollers is 38 mm, and the requirement of the small robot moving platform is met.

Further, the first fixed bottom cover and the second fixed bottom cover are provided with a groove and a rolling shaft groove corresponding to the grooves in the two sides of the middle fixed base respectively.

Further, the first fixed bottom cover and the second fixed bottom cover are respectively fixed on the two sides of the middle fixed base through five screws.

Further, a width between two parallel small rollers is 20 mm, and the flat design makes the appearance of the omni-directional wheel is more attractive.

Further, the rubber sleeve and the small roller are in transition fit.

Further, the small roller and the small roller rolling shaft are made of high-strength plastic materials, so that the weight is further reduced.

Further, a locating pin is arranged between the grooves of the first fixed bottom cover and the second fixed bottom cover, and the locating pin is connected with a locating hole between the two grooves in the two sides of the middle fixed base in a transition fit.

Further, the small roller is arc-shape.

Compared with the prior art, the small double-row omni-directional wheel has the beneficial effects that: the present invention has the characteristics of low cost, simple structure, light weight, long service life, attractive appearance, high moving speed and high cost performance, and is suitable for a small-sized robot movement platform.

### BRIEF DESCRIPTION OF THE DRAWINGS

FIG. 1 is an isometric view of a small double-row omni-directional wheel provided by the present invention..

FIG. 2 is a front view of a small double-row omni-directional wheel provided by the present invention.

FIG. 3 is a left view of a small double-row omni-directional wheel provided by the present invention.

FIG. 4 is a schematic diagram of a middle fixed base of a small double-row omni-directional wheel provided by the present invention.

FIG. 5 is an exploded view of a small double-row omni-directional wheel provided by the present invention..

Wherein, the reference numerals in the figures are as follows: 1 is the middle fixed base, 2 is the groove, 21 is the rolling shaft groove, 3 is the small roller assembly, 31 is the small roller, 32 is the small roller rolling shaft, 33 is the rubber sleeve, 4 is the first fixed bottom cover, 5 is the second fixed bottom cover, 6 is the locating hole, 7 is the locating pin, 8 is the screw and 9 is the motor rotating shaft mounting hole.

### DETAILED DESCRIPTION OF THE PRESENT INVENTION

In order to enable the technical scheme and the advantages of the present invention to be better understood, the present invention is further described in detail with the accompanying drawings and embodiments. It should be understood that the specific embodiments described herein are only used to explain the present invention, and is not used for limiting the present invention. Based on the embodiments of the present invention, all other embodiments obtained by those ordinary skilled in the art without making creative efforts are all within the protection scope of the present invention.

In the description of the present invention, it should be noted that the terms “ center ”, “ upper ”, “ lower ”, “ left ”, “ right ” , “ vertical ”, “ horizontal ”, “ inner ”, “ outer ” and the like, indicating the orientation or position relation are based on the orientation or position relation shown in the figure. These terms facilitate describing the present invention and simplifying the description, but not indicating or implying that the indicated devices or elements must have a specific orientation and be constructed and operated in a specific orientation, therefore, it cannot be construed as a limitation of the present invention. In addition, the terms “ first ”, “ second ” and “ third ” are used only for description purposes and cannot be understood as indicating or implying relative importance.

In the description of the present invention, it should also be noted that, unless expressly stated and limited otherwise, the terms “ mounting ” , “ join” and “ connection ” should be construed broadly; for example, it can be fixedly connection, detachably connection or integrally connection; it can also be mechanically connection or electrically connection; besides, it can be directly connection or indirectly connection through an intermediate medium or can be internal connection of two elements. For those ordinary skilled in the art, the specific meaning of the terms in the present invention can be understood in a specific situation.

The preferable implementation mode provided by the present invention is specifically described in the following with reference to the accompanying drawings.

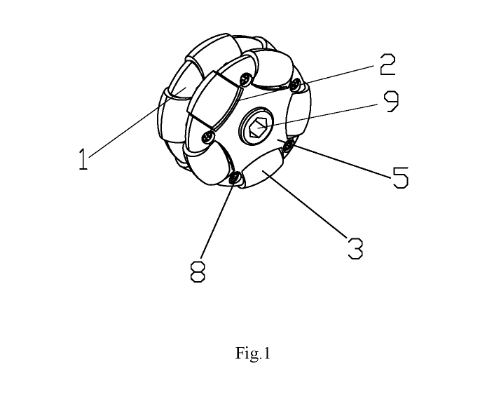

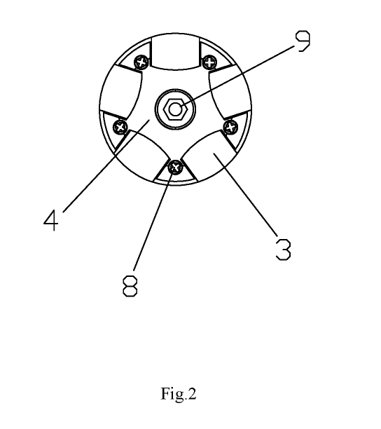

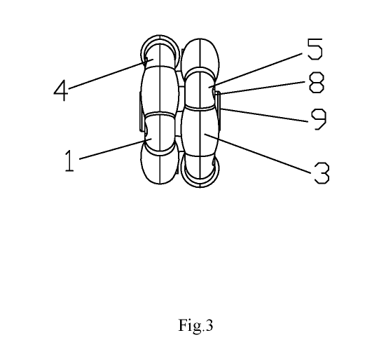

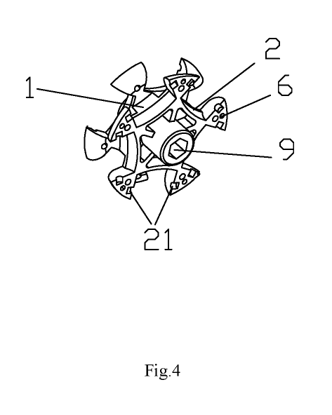

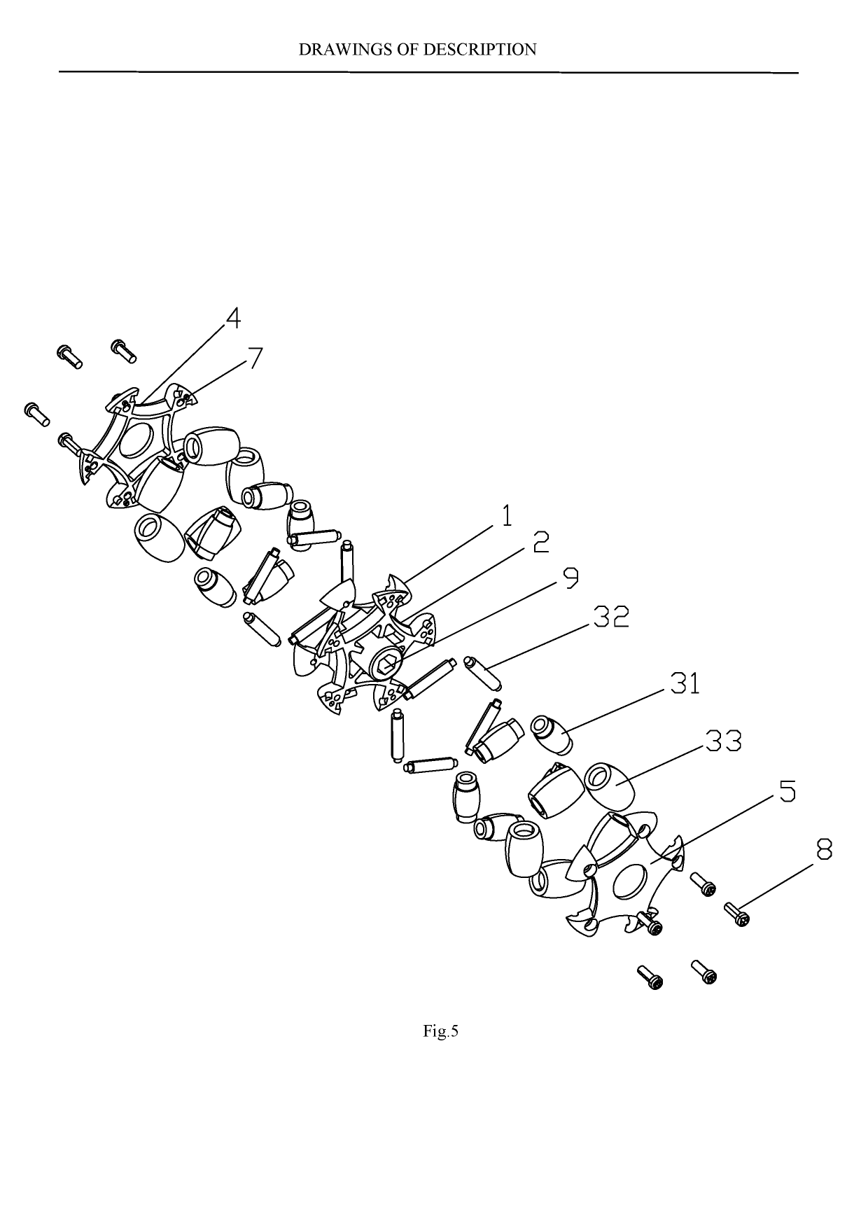

As shown in FIG. 1 to FIG. 5, the present invention provides a small double-row omni-directional wheel. The small double-row omni-directional wheel comprises a middle fixed base 1, a first fixed bottom cover 4, a second fixed bottom cover 5 and a small roller assembly 3; the middle of the middle fixed base 1 is provided with a motor rotating shaft mounting hole 9 for fixedly connecting with a motor rotating shaft, and the middle fixed base 1 is driven by a motor to rotate around the axis; two rows of mutually parallel staggered grooves 2 perpendicular to the axis of the middle fixed base are uniformly arranged in the two sides of the middle fixed base 1, the number of the grooves 2 is 10, and the number of grooves for each row is 5; the small roller assembly 3 is fixed in the grooves 2, that is, the axis of the middle fixed base 1 is perpendicular to the axis of the small roller 31; the first fixed bottom cover 4 and the second fixed bottom cover 5 are respectively fixed on the two sides of the middle fixed base 1; the small roller assembly 3 comprises a small roller 31, a small roller rolling shaft 32 and a rubber sleeve 33; a rolling shaft groove 21 is arranged in the two sides of the middle of each grooves 2, the small roller rolling shaft 32 is arranged in the rolling shaft groove 21, and the small roller 31 is rotatably fixed on the small roller rolling shaft 32 and rotates around the rolling shaft 32, and the small roller 31 is in contact with the ground in sequence and freely rotates around the self axis; the rubber sleeve 33 is wrapped on the outer surface of the small roller 31, effectively reducing the vibration. In this way, the height of the contact points of the wheels and the ground in the rotating process is not changed and avoiding vibration of the robot, it is also guaranteed that the small roller 31 can freely roll in the parallel direction of the wheel disc shaft at any position. The operation of the wheel is more stable, and noise is effectively reduced.

Specifically, the middle fixed base 1, the first fixed bottom cover 4 and the second fixed bottom cover 5 are made of high-strength plastic materials and integrally formed, so that the weight is effectively reduced, and the requirement for portability of the small robot is met.

Specifically, an included angle between the two adjacent small rollers 31 is 72 degrees, an angle of 36 degrees is formed between two rows of the small rollers 31 in a staggered mode, and the outer circle diameter formed by fitting each row of the small rollers is 38 mm, and the requirement of the small robot moving platform is met.

Specifically, a groove and a rolling shaft groove corresponding to the grooves in the two sides of the middle fixed base are provided in the first fixed bottom cover 4 and the second fixed bottom cover 5 respectively.

Specifically, the first fixed bottom cover 4 and the second fixed bottom cover 5 are respectively fixed on the two sides of the middle fixed base 1 through five screws.

Specifically, the width between the two parallel small rollers 31 is 20 mm, and the flat design makes the appearance of the omni-directional wheel more attractive.

Specifically, the rubber sleeve 33 and the small roller 31 are in transition fit.

Specifically, the small roller 31 and the small roller rolling shaft 32 are made of high-strength plastic materials, so that the weight is further reduced.

Specifically, a locating pin 7 is arranged between the grooves of the first fixed bottom cover 4 and the second fixed bottom cover 5, and is connected with a locating hole 6 between the two grooves in the two sides of the middle fixed base in a transition fit.

Specifically, the small roller 31 is arc-shape.

The above descriptions is only a preferred embodiment of the present invention, and it is obvious that the implementation of the present invention is not limited to the solutions. Any modification, equivalent replacement, improvement and the like of the conception and the technical scheme of the method disclosed by the invention, or the conception and the technical scheme of the invention directly applied to other occasions without improvement, are all included in the protection scope of the invention.

What is claimed is:

1. A small double-row omni-directional wheel, comprising: a middle fixed base, a first fixed bottom cover, a second fixed bottom cover and a small roller assembly; wherein the middle of the middle fixed base is provided with a motor rotating shaft mounting hole for fixedly connecting with a motor rotating shaft; two rows of mutually parallel staggered grooves perpendicular to the axis of the middle fixed base are uniformly arranged in two sides of the middle fixed base; the small roller assembly is fixed in the grooves; the first fixed bottom cover and the second fixed bottom cover are respectively fixed on the two sides of the middle fixed base; the small roller assembly comprises a small roller, a small roller rolling shaft and a rubber sleeve; a rolling shaft groove is arranged in two sides of the middle of each grooves; the small roller rolling shaft is arranged in the rolling shaft groove, and the small roller is rotatably fixed on the small roller rolling shaft and rotates around the rolling shaft; and the rubber sleeve is wrapped on an outer surface of the small roller.

2. The small double-row omni-directional wheel according to claim 1, characterized in that the number of the grooves is 10, and the number of grooves for each row is 5.

3. The small double-row omni-directional wheel according to claim 1, characterized in that the middle fixed base, the first fixed bottom cover and the second fixed bottom cover are made of plastic materials and integrally formed.

4. The small double-row omni-directional wheel according to claim 1, characterized in that an included angle between two adjacent small rollers is 72 degrees, an angle of 36 degrees is formed between two rows of the small rollers in a staggered mode, and an outer circle diameter formed by fitting each row of the small rollers is 38 mm.

5. The small double-row omni-directional wheel according to claim 1, characterized in that the first fixed bottom cover and the second fixed bottom cover are provided with a groove and a rolling shaft groove corresponding to the grooves in the two sides of the middle fixed base respectively.

6. The small double-row omni-directional wheel according to claim 1, characterized in that the first fixed bottom cover and the second fixed bottom cover are respectively fixed on the two sides of the middle fixed base through a screw.

7. The small double-row omni-directional wheel according to claim 1, characterized in that a width between two parallel small rollers is 20 mm.

8. The small double-row omni-directional wheel according to claim 1, characterized in that the small roller is arc-shape, and the rubber sleeve and the small roller are in a transition fit.

9. The small double-row omni-directional wheel according to claim 1, characterized in that the small roller and the small roller rolling shaft are made of plastic materials.

10. The small double-row omni-directional wheel according to claim 1, characterized in that a locating pin is arranged between the grooves of the first fixed bottom cover and the second fixed bottom cover, and the locating pin is connected with a locating hole between the two grooves in the two sides of the middle fixed base in a transition fit.
